(19) United States
(12) Patent Application Publication
(10) Pub. No.: US 2022/0237521 A1
(43) Pub. Date: Jul. 28, 2022

(54) METHOD, DEVICE, AND COMPUTER PROGRAM PRODUCT FOR UPDATING MACHINE LEARNING MODEL

(71) Applicant: EMC IP Holding Company LLC, Hopkinton, MA (US)

(72) Inventors: Jinpeng Liu, Shanghai (CN); Jin Li, Shanghai (CN); Jiacheng Ni, Shanghai (CN); Qiang Chen, Shanghai (CN); Zhen Jia, Shanghai (CN)

(21) Appl. No.: 17/189,993

(22) Filed: Mar. 2, 2021

(30) Foreign Application Priority Data
Jan. 28, 2021 (CN) 202110121211.0

(51) Int. Cl. G06N 20/20; G16Y 40/35; G06N 3/04; G06F 9/50

(52) U.S. Cl. CPC G06N 20/20; G06F 9/5077; G06N 3/0454; G16Y 40/35

(57) ABSTRACT

Embodiments of the present disclosure provide a method, a device, and a computer program product for updating a machine learning model. The method may include: determining, with a first machine learning model deployed at a first computing device, a first analysis result for to-be-analyzed data received from a data collector. The method may further include: determining, with a second machine learning model received from a second computing device, a second analysis result for the to-be-analyzed data, the second computing device being different from the first computing device. In addition, the method may further include: determining, based on a comparison of the first analysis result and the second analysis result, a target machine learning model from the first machine learning model and the second machine learning model for use in analyzing additional to-be-analyzed data received from the data collector.

### RELATED APPLICATION(S)

The present application claims priority to Chinese Patent Application No. 202110121211.0, filed Jan. 28, 2021, and entitled “Method, Device, and Computer Program Product for Updating Machine Learning Model,” which is incorporated by reference herein in its entirety.

### FIELD

Embodiments of the present disclosure relate to the field of artificial intelligence and the field of the Internet of Things, and more particularly, to a method, a device, and a computer program product for updating a machine learning model.

### BACKGROUND

In recent years, with the development of computer technology, the Internet of Things (IoT) has been increasingly applied in various aspects of people's lives. A core aspect of IoT technology is the analysis of data obtained from IoT devices (e.g., various temperature sensors, position sensors, image sensors, meters, etc.), and these sensor data can be used to implement corresponding intelligent control functions based on technologies related to artificial intelligence.

In order to implement intelligent control functions, it is necessary, for example, to arrange a machine learning model in the field. Apparently, the machine learning model needs to be updated over a period of time in order to acquire more accurate analysis results with the updated machine learning model. However, for various reasons, there is a risk that the analysis results from the updated machine learning model will be degraded.

### SUMMARY

Embodiments of the present disclosure provide a method, a device, and a computer program product for updating a machine learning model.

In a first aspect of the present disclosure, a method for updating a machine learning model is provided. The method may include: determining, with a first machine learning model deployed at a first computing device, a first analysis result for to-be-analyzed data received from a data collector. The method may further include: determining, with a second machine learning model received from a second computing device, a second analysis result for the to-be-analyzed data, the second computing device being different from the first computing device. In addition, the method may further include: determining, based on a comparison of the first analysis result and the second analysis result, a target machine learning model from the first machine learning model and the second machine learning model for use in analyzing additional to-be-analyzed data received from the data collector.

According to a second aspect of the present disclosure, an electronic device is provided. The electronic device includes: a processor; and a memory, which stores computer program instructions. The processor runs the computer program instructions in the memory to control the electronic device to perform actions including: determining, with a first machine learning model deployed at a first computing device, a first analysis result for to-be-analyzed data received from a data collector; determining, with a second machine learning model received from a second computing device, a second analysis result for the to-be-analyzed data, the second computing device being different from the first computing device; and determining, based on a comparison of the first analysis result and the second analysis result, a target machine learning model from the first machine learning model and the second machine learning model for use in analyzing additional to-be-analyzed data received from the data collector.

According to a third aspect of the present disclosure, a computer program product is provided, which is tangibly stored on a non-volatile computer-readable medium and includes machine-executable instructions, wherein the machine-executable instructions, when executed, cause a machine to perform the steps of the method in the first aspect of the present disclosure.

### BRIEF DESCRIPTION OF THE DRAWINGS

The above and other objectives, features, and advantages of the present disclosure will become more apparent by the detailed description below of example embodiments of the present disclosure, with reference to the accompanying drawings, and in the example embodiments of the present disclosure, the same reference numerals generally represent the same components.

FIG. 1 illustrates a schematic diagram of an example environment in which multiple embodiments of the present disclosure can be implemented;

FIG. 2 illustrates a schematic diagram of a detailed example environment according to embodiments of the present disclosure;

FIG. 3 illustrates a schematic diagram of a detailed example environment for data analysis according to embodiments of the present disclosure;

FIG. 4 illustrates a flow chart of a process for updating a machine learning model according to embodiments of the present disclosure;

FIG. 5 illustrates a flow chart of a detailed process for updating a machine learning model according to embodiments of the present disclosure; and

FIG. 6 illustrates a schematic block diagram of an example device suitable for use to implement embodiments of the present disclosure.

The same or corresponding reference numerals in the various drawings represent the same or corresponding portions.

### DETAILED DESCRIPTION

Hereinafter, the embodiments of the present disclosure will be described in more detail with reference to the accompanying drawings. Although some embodiments of the present disclosure are illustrated in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and embodiments of the present disclosure are for illustrative purposes only, and are not intended to limit the scope of protection of the present disclosure.

In the description of the embodiments of the present disclosure, the term “include” and similar terms thereof should be understood as open-ended inclusion, i.e., “including but not limited to.” The term “based on” should be understood as “based at least in part on.” The term “one embodiment” or “the embodiment” should be understood as “at least one embodiment.” The terms “first,” “second,” etc. may refer to different or the same objects. Other explicit and implicit definitions may also be included below.

The principles of the present disclosure will be described below with reference to several example embodiments shown in the accompanying drawings. Although illustrative embodiments of the present disclosure are shown in the accompanying drawings, it should be understood that these embodiments are described only to enable those skilled in the art to better understand and then implement the present disclosure, and are not intended to impose any limitation to the scope of the present disclosure.

As used herein, “machine learning” refers to processing involving high-performance computing, machine learning, and artificial intelligence algorithms. Herein, the term “machine learning model” may also be referred to as a “learning model,” “learning network,” “network model,” or “model.” A “neural network” or “neural network model” is a deep learning model. To summarize, a machine learning model is capable of receiving input data, performing predictions based on input data, and outputting prediction results.

Typically, in order to efficiently implement the use of a machine learning model, the machine learning model is often arranged at an edge computing node close to a data collector, and computing devices such as those in cloud computing architectures are used to train an updated version of the machine learning model. It should be understood that there is a need for updating the machine learning model in order to optimize the performance of data analysis. Therefore, by training the machine learning model with newly collected training datasets at the computing device side of the cloud computing architecture and updating the machine learning model currently in use at the edge computing node side with the trained machine learning model, the system performance can generally be improved. However, the machine learning model trained with the newly collected training dataset may perform slightly worse than the machine learning model currently in use due to possible differences between the training dataset and the data collected in the field. Therefore, an update mechanism is urgently needed to avoid the above situation.

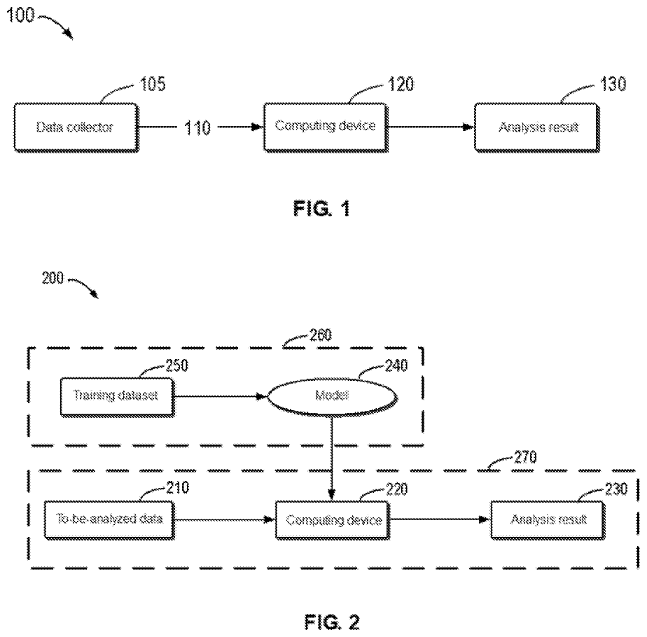

In response to the above problem and potentially other related problems, the present disclosure provides a solution for updating a machine learning model. According to this solution, after receiving an updated version of the machine learning model from the computing device side of the cloud computing architecture, the to-be-analyzed data received from the data collector can be input into both the machine learning model currently in use and the updated version of the machine learning model, and it can be determined, based on the output results of the two models, whether to use the updated version of the machine learning model to replace the machine learning model currently in use. To better understand the process of updating a machine learning model according to embodiments of the present disclosure, the overall architecture of the present disclosure will first be described below with reference to FIG. 1.

FIG. 1 illustrates a schematic diagram of example environment 100 in which multiple embodiments of the present disclosure can be implemented. As shown in FIG. 1, example environment 100 contains data collector 105, computing device 120 for receiving to-be-analyzed data 110 from data collector 105, and analysis result 130 calculated by computing device 120.

It should be understood that data collector 105 can be any apparatus that quantifies the state of a monitored object into sensing data, for example, it can be a variety of similar sensors.

Examples of data collectors 105 include image sensors, motion sensors, temperature sensors, position sensors, illumination sensors, humidity sensors, power sensing sensors, gas sensors, smoke sensors, humidity sensors, pressure sensors, positioning sensors, accelerometers, gyroscopes, meters, sound decibel sensors, and the like. In the field of autonomous driving, data collector 105 can be an image acquisition apparatus or LIDAR arranged on a smart car. In the field of smart homes, data collector 105 can be an image acquisition apparatus or an infrared sensing apparatus arranged near or inside a certain place. In addition, in the field of smart irrigation, data collector 105 can be a sensor for monitoring temperature, humidity, soil pH, and the like.

Data collector 105 sends the collected field data to computing device 120 in real time or periodically as to-be-analyzed data 110. Computing device 120 can be an edge computing node arranged in the field or at a position close to the field for determining analysis result 130 of to-be-analyzed data 110 with a machine learning model. It should be understood that computing device 120 can be a lightweight computing device due to the small amount of computing resources consumed by the data analysis with the machine learning model. Moreover, because computing device 120 is set up to be close to the field, computation tasks can be completed quickly and in a timely manner. Based on a similar design, the machine learning model in computing device 120 is typically not trained in computing device 120. The training and use of the model in computing device 120 are described in detail below with reference to FIG. 2.

FIG. 2 illustrates a schematic diagram of detailed example environment 200 according to embodiments of the present disclosure. Like FIG. 1, example environment 200 may contain computing device 220, to-be-analyzed data 210, and analysis result 230. The difference is that example environment 200 may include model training system 260 and model application system 270 in general. As an example, model application system 270 may be implemented in computing device 120 as shown in FIG. 1 or computing device 220 as shown in FIG. 2, and model training system 260 may be implemented in a computing device such as in a cloud computing architecture. It should be understood that the structure and function of example environment 200 are described for example purposes only, and are not intended to limit the scope of the subject matter described herein. The subject matter described herein may be implemented in different structures and/or functions.

As previously described, the process of determining the analysis result for the to-be-analyzed data can be divided into two stages: a model training stage and a model application stage. As an example, in the model training stage, model training system 260 can use training dataset 250 to train model 240. In the model application stage, model application system 270 can receive the trained model 240 so that model 240 determines, based on to-be-analyzed data 210, analysis result 230 such as the corresponding driving strategy, home alarm strategy, or irrigation strategy.

In other embodiments, model 240 can be constructed as a learning network. In some embodiments, this learning network may include multiple networks, wherein each network may be a multilayer neural network that may comprise a large number of neurons. Through the training process, corresponding parameters of the neurons in each network can be determined. The parameters of the neurons in these networks are collectively referred to as parameters of model 240. In addition, model 240 may also be a support vector machine (SVM) model, Bayesian model, random forest model, various deep learning/neural network models such as convolutional neural network (CNN), recurrent neural network (RNN), etc.

The training process of model 240 can be performed in an iterative manner. Specifically, model training system 260 can acquire sample data from training dataset 250 and use that sample data to perform one iteration of the training process to update corresponding parameters of model 240. Model training system 260 can perform the above process based on multiple pieces of sample data in training dataset 250 until at least some of the parameters of model 240 converge or until the iterations have reached a predetermined number of iterations, thereby obtaining the final model parameters.

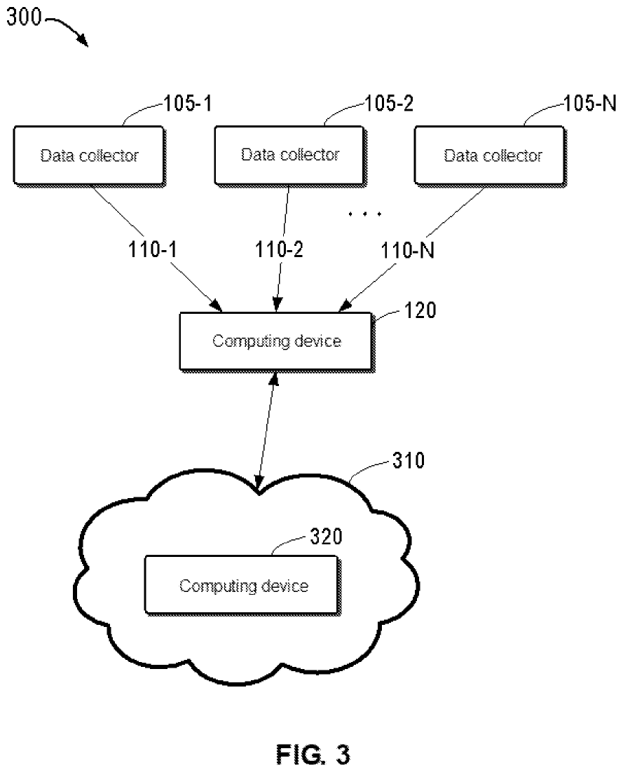

FIG. 3 illustrates a schematic diagram of detailed example environment 300 for data analysis according to embodiments of the present disclosure. As shown in FIG. 3, detailed example environment 300 includes one or more data collectors 105-1, 105-2, . . . , and 105-N (individually or collectively referred to as data collector 105, where N is a positive integer greater than or equal to 1), computing device 120, cloud computing architecture 310, and computing device 320 that is provided in cloud computing architecture 310. It should be understood that the number and arrangement of devices shown in FIG. 3 are only schematic and should not be construed as a limitation to the solution of the present application.

In some embodiments, computing device 120 may be an edge computing node, such as a computing node with gateway functionality (also referred to as an edge gateway). Computing device 120 may be in wired or wireless connection and communication with one or more data collectors 105, and configured to receive to-be-analyzed data 110-1, 110-2, . . . , and 110-N (individually or collectively referred to as to-be-analyzed data 110) from one or more data collectors 105.

It should be understood that cloud computing architecture 310 can be remotely arranged to provide services such as computation, data access, and storage. Processing in cloud computing architecture 310 can be referred to as “cloud computing.” In various implementations, cloud computing provides services via a wide area network (e.g., the Internet) with appropriate protocols. For example, one or more providers of cloud computing architecture 310 offer applications via the wide area network and such applications can be accessed through a web browser or any other computing component. Software or components of cloud computing architecture 310 and corresponding data can be stored on a server at a remote position. Computing resources in cloud computing architecture 310 can be merged at a remote data center position or they may be dispersed. Cloud computing infrastructures can provide services through a shared data center, even if they are each represented as a single access point for users. Therefore, the components and functions described herein can be provided from a service provider at a remote position with cloud computing architecture 310. Alternatively, they can be provided from a conventional server, or they can be installed on a client device directly or in other manners. It should also be understood that computing device 320 can be any component of cloud computing architecture 310 that has computing capability. Thus, the various parts of computing device 320 can be distributed in cloud computing architecture 310.

It should be understood that computing device 120 is arranged with a first machine learning model currently in use. Computing device 320 can be a device with stronger computing capability and therefore can be used to implement model training. For example, computing device 320 can send the configuration data of the trained first machine learning model and the values of the parameters obtained through the training to computing device 120 via cloud computing architecture 310. When version updating is required, computing device 320 can further transmit the updated second machine learning model to computing device 120 via cloud computing architecture 310. As a result, computing device 120 will use the second machine learning model to update the first machine learning model.

To ensure that this updating operation does not degrade the system performance, the second machine learning model can be validated. For example, after determining that computing device 120 has sufficient computing resources, computing device 120 can input the received to-be-analyzed data 110 into the first machine learning model and the second machine learning model, respectively, and compare the analysis results output by the first machine learning model and the second machine learning model. Computing device 120 can determine, based on a result of the comparison, whether to update the first machine learning model with the second machine learning mode.

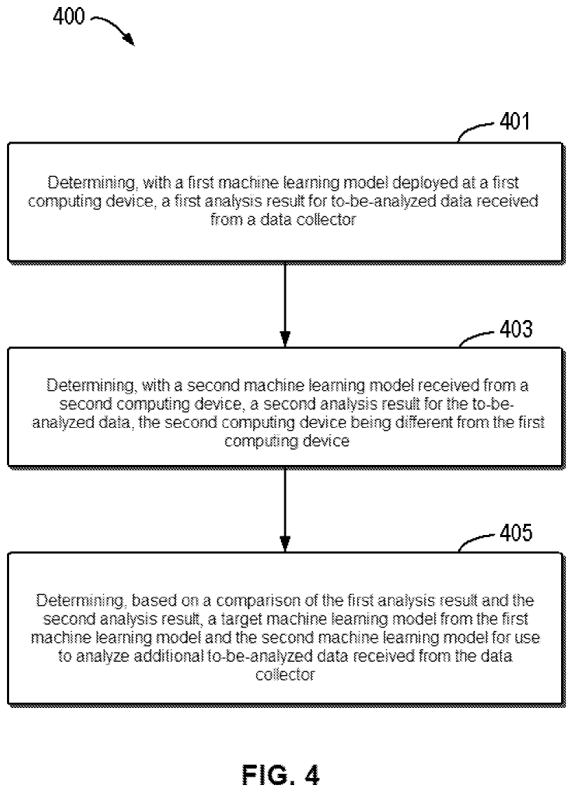

Computing device 120 of the present disclosure can ensure that the updating operation does not degrade the system performance by performing a process for updating the machine learning model as shown in FIG. 4. The flow chart of the process for updating the machine learning model will be described in detail below in connection with FIG. 4.

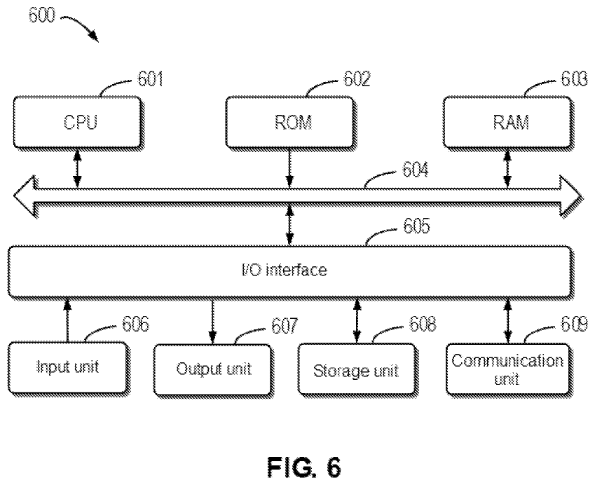

FIG. 4 illustrates a flow chart of process 400 for updating a machine learning model according to embodiments of the present disclosure. In some embodiments, process 400 can be implemented in a device shown in FIG. 6. For ease of understanding, specific data mentioned in the following description are all examples and are not intended to limit the scope of protection of the present disclosure.

At 401, a first analysis result for to-be-analyzed data 110 received from data collector 105 can be determined with a first machine learning model deployed in computing device 120. In some embodiments, the computing capability of computing device 120 is lower than the computing capability of computing device 320 arranged in cloud computing architecture 310, and the speed of communication between computing device 120 and data collector 105 is higher than the speed of communication between computing device 320 and data collector 105. In this manner, computing device 320 in cloud computing architecture 310 can be used to quickly train the machine learning model and the speed of communication of computing device 120 can be used to process the received to-be-analyzed data 110 in a timely manner.

As an example, computing device 120 can be an edge computing node that is arranged as data collector 105 adjacent to the field. Computing device 320 is included in cloud computing architecture 310 and data collector 105 includes sensors in the Internet of Things (IoT). It should be understood that the architectural arrangement described in this embodiment is only an example, and the technical solution to be protected by the present disclosure is not limited thereto.

At 403, a second machine learning model received from computing device 320 can be used to determine a second analysis result for to-be-analyzed data 110. In some embodiments, before processing to-be-analyzed data 110 with the second machine learning model, a first computing resource that is used to determine the first analysis result with the first machine learning model and a second computing resource that is used to determine the second analysis result with the second machine learning model can be first determined. The second analysis result can be determined with the second machine learning model if it is determined that the sum of the first computing resource and the second computing resource is less than or equal to a threshold computing resource. As an example, the threshold computing resource can be the maximum computing power of computing device 120. In this manner, the first machine learning model and the second machine learning model can be used at the same time to process the received to-be-analyzed data 110 if it is determined that sufficient computing resources are available, thus avoiding delays in generating analysis results due to insufficient computing resources.

Additionally or alternatively, before determining whether the maximum computing power of computing device 120 can perform the processing by the two machine learning models on to-be-analyzed data 110 in parallel, it may be determined first whether a complete second machine learning model is successfully loaded on computing device 120. In this manner, the situation can be avoided where the subsequent updating process interrupts a service being provided.

It should be understood that the above solution is only an example, and for systems with low timeliness requirements, such as smart irrigation, there is no need to determine in advance whether sufficient computing resources are available or whether the second machine learning model is successfully loaded.

At 405, a target machine learning model can be determined from the first machine learning model and the second machine learning model based on the comparison of the first analysis result and the second analysis result. This target machine learning model can continue to process subsequent to-be-analyzed data received from data collector 105. In this manner, the present disclosure can complete the updating of the machine learning model with virtually no delay in processing to-be-analyzed data.

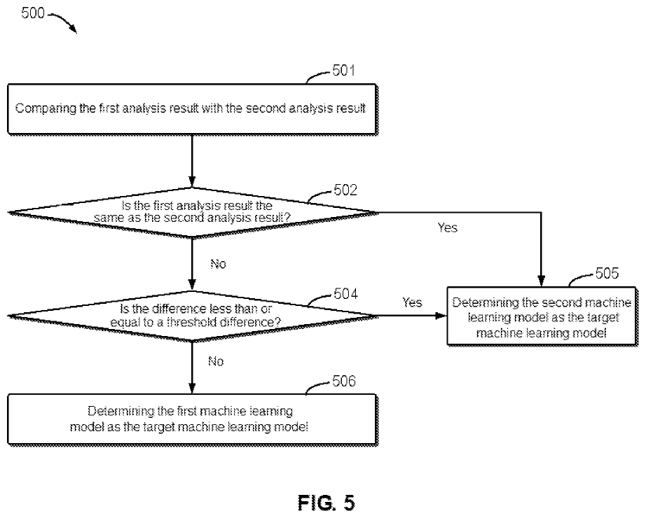

It should be understood that the reason for determining whether to use the second machine learning model based on the result of the comparison of the first analysis result and the second analysis result is that there are cases where the second analysis result is worse than the first analysis result. Specifically, if the second analysis result, individually or as a whole, is worse than the first analysis result, the first machine learning model is determined as the target machine learning model, i.e., no updates are made to the first machine learning model. FIG. 5 illustrates a flow chart of detailed process 500 for updating a machine learning model according to embodiments of the present disclosure.

At 501, the first analysis result can be compared with the second analysis result. For example, it may be determined at 502 whether first analysis result is the same as the second analysis result. If the first analysis result is the same as the second analysis result, it indicates that the second machine learning model can be used to update the first machine learning model, so at 505, the second machine learning model can be determined as the target machine learning model. Otherwise, the determination can be continued, at 504, as to whether the difference between the first analysis result and the second analysis result is less than or equal to a threshold difference. If this difference is less than or equal to the threshold difference, it indicates that the second machine learning model can be used to update the first machine learning model, so at 505, the second machine learning model can be determined as the target machine learning model. Otherwise, at 506, the first machine learning model can be determined as the target machine learning model, i.e., no updates are made to the first machine learning model. As an example, this threshold difference can be determined by computing device 320 when training the second machine learning model. As an example, two parameters can be set in advance, i.e., the number of validation successes and the number of validation failures. If it is determined that the first analysis result is the same as the second analysis result, the number of validation successes is incremented by one. In addition, in the case where the first analysis result is different from the second analysis result, if the difference between the first analysis result and the second analysis result is determined to comply with a predetermined rule generated when training the second machine learning model, the number of validation successes is incremented by one, while if the difference between the first analysis result and the second analysis result is determined not to comply with the predetermined rule generated when training the second machine learning model, the number of validation failures is incremented by one. Thus, the ratio of the number of validation failures to the number of validation successes or the total number of validations can be determined. If this ratio is lower than a threshold ratio, it indicates that second machine learning model passes the validation and the machine learning model can be updated. In this manner, it is possible to quickly determine whether the second machine learning model is suitable for model updating, thus ensuring that the updated model does not degrade the system performance.

In some embodiments, when the second machine learning model is determined to be suitable for model updating, the first machine learning model can also be updated with the second machine learning model that is determined as the target machine learning model. In this manner, after the first machine learning model has completed the processing of the current to-be-analyzed data 110, the validated second machine learning model can be used to continue processing the subsequent to-be-analyzed data, so that the updating of the machine learning model can be completed with virtually no delay in processing the to-be-analyzed data.

In some embodiments, to-be-analyzed data 110 and the analysis results obtained from processing by both the first machine learning model and the second machine learning model can be uploaded to computing device 320. In addition, when the validation process described above determines that the second machine learning model cannot replace the first machine learning model, a manual determination can be made based on the uploaded data, and the data analysis operation can still be performed by the first machine learning model in the meantime. In this manner, a manual validation approach can be introduced.

With the above embodiment, the updating of the machine learning model can be completed without affecting the ongoing data analysis operation. In addition, since both the loading status of the model and the computing resources for model validation have been checked before updating the model, it is possible to ensure that the ongoing data analysis operation is not interrupted by unexpected events, thus improving the reliability of the system. In addition, since the model validation process can be executed before updating the model, the updated version of the model can be validated with actual data in the field, so the performance improvement of the updated model can be guaranteed.

FIG. 6 illustrates a schematic block diagram of example device 600 suitable for use to implement embodiments of the present disclosure. As shown in the figure, device 600 includes central processing unit (CPU) 601 that may perform various appropriate actions and processing according to computer program instructions stored in read-only memory (ROM) 602 or computer program instructions loaded from storage unit 608 into random access memory (RAM) 603. In RAM 603, various programs and data required for operations of device 600 may also be stored. CPU 601, ROM 602, and RAM 603 are connected to each other through bus 604. Input/output (I/O) interface 605 is also connected to bus 604.

Multiple components in device 600 are connected to I/O interface 605, including: input unit 606, such as a keyboard and a mouse; output unit 607, such as various types of displays and speakers; storage unit 608, such as a magnetic disk and an optical disc; and communication unit 609, such as a network card, a modem, and a wireless communication transceiver. Communication unit 609 allows device 600 to exchange information/data with other devices over a computer network such as an Internet and/or various telecommunication networks.

Various processes and processing described above, for example, processes 400 and/or 500, can be performed by CPU 601. For example, in some embodiments, processes 400 and/or 500 may be implemented as a computer software program that is tangibly included in a machine-readable medium, for example, storage unit 608. In some embodiments, part or all of the computer program may be loaded and/or installed onto device 600 via ROM 602 and/or communication unit 609. When the computer program is loaded into RAM 603 and executed by CPU 601, one or more actions of processes 400 and/or 500 described above may be performed.

Illustrative embodiments of the present disclosure include a method, an apparatus, a system, and/or a computer program product. The computer program product may include a computer-readable storage medium on which computer-readable program instructions for performing various aspects of the present disclosure are loaded.

The computer-readable storage medium may be a tangible device that can hold and store instructions used by an instruction execution device. For example, the computer-readable storage medium may be, but is not limited to, an electrical storage device, a magnetic storage device, an optical storage device, an electromagnetic storage device, a semiconductor storage device, or any appropriate combination of the above. More specific examples (a non-exhaustive list) of the computer-readable storage medium include: a portable computer disk, a hard disk, a RAM, a ROM, an erasable programmable read-only memory (EPROM or flash memory), a static random access memory (SRAM), a portable compact disk read-only memory (CD-ROM), a digital versatile disk (DVD), a memory stick, a floppy disk, a mechanical coding device such as a punch card or protrusions in a groove on which instructions are stored, and any appropriate combination of the above. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein can be downloaded from a computer-readable storage medium to various computing/processing devices, or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium in each computing/processing device.

The computer program instructions for executing the operation of the present disclosure may be assembly instructions, an instruction set architecture (ISA) instructions, machine instructions, machine-dependent instructions, microcode, firmware instructions, state setting data, or source code or object code written in any combination of one or more programming languages, including an object oriented programming language, such as Smalltalk, C++, and the like, and conventional procedural programming languages, such as the “C” language or similar programming languages. The computer-readable program instructions may be executed entirely on a user's computer, partly on a user's computer, as a stand-alone software package, partly on a user's computer and partly on a remote computer, or entirely on a remote computer or a server. In a case where a remote computer is involved, the remote computer can be connected to a user computer through any kind of networks, including a local area network (LAN) or a wide area network (WAN), or can be connected to an external computer (for example, connected through the Internet by an Internet service provider). In some embodiments, an electronic circuit, such as a programmable logic circuit, a field programmable gate array (FPGA), or a programmable logic array (PLA), may be customized by utilizing status information of the computer-readable program instructions. The electronic circuit may execute the computer-readable program instructions to implement various aspects of the present disclosure.

Various aspects of the present disclosure are described herein with reference to flow charts and/or block diagrams of the method, the apparatus (system), and the computer program product implemented according to the embodiments of the present disclosure. It should be understood that each block of the flow charts and/or block diagrams and combinations of blocks in the flow charts and/or block diagrams can be implemented by computer-readable program instructions.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or more blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or more blocks in the flow charts and/or block diagrams.

The computer-readable program instructions may also be loaded to a computer, a further programmable data processing apparatus, or a further device, so that a series of operating steps may be performed on the computer, the further programmable data processing apparatus, or the further device to produce a computer-implemented process, such that the instructions executed on the computer, the further programmable data processing apparatus, or the further device may implement the functions/actions specified in one or more blocks in the flow charts and/or block diagrams.

The flow charts and block diagrams in the drawings illustrate the architectures, functions, and operations of possible implementations of the systems, methods, and computer program products according to various embodiments of the present disclosure. In this regard, each block in the flow charts or block diagrams may represent a module, a program segment, or part of an instruction, the module, program segment, or part of an instruction including one or more executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in an inverse order, which depends on involved functions. It should be further noted that each block in the block diagrams and/or flow charts as well as a combination of blocks in the block diagrams and/or flow charts may be implemented in a special hardware-based system that executes specified functions or actions, or in a combination of special hardware and computer instructions.

Various embodiments of the present disclosure have been described above. The foregoing description is illustrative rather than exhaustive, and is not limited to the disclosed embodiments. Numerous modifications and alterations are apparent to those of ordinary skill in the art without departing from the scope and spirit of the illustrated embodiments. The selection of terms as used herein is intended to best explain the principles and practical applications of the various embodiments or technical improvements of technologies on the market, and to otherwise enable persons of ordinary skill in the art to understand the embodiments disclosed here.

What is claimed is:

1. A method for updating a machine learning model, comprising:
determining, with a first machine learning model deployed at a first computing device, a first analysis result for to-be-analyzed data received from a data collector;
determining, with a second machine learning model received from a second computing device, a second analysis result for the to-be-analyzed data, the second computing device being different from the first computing device; and
determining, based on a comparison of the first analysis result and the second analysis result, a target machine learning model from the first machine learning model and the second machine learning model for use in analyzing additional to-be-analyzed data received from the data collector.

2. The method according to claim 1, wherein determining the second analysis result with the second machine learning model comprises:
determining a first computing resource that is used to determine the first analysis result with the first machine learning model and a second computing resource that is used to determine the second analysis result with the second machine learning model; and
determining the second analysis result with the second machine learning model when determining that the sum of the first computing resource and the second computing resource is less than or equal to a threshold computing resource.

3. The method according to claim 1, wherein determining the target machine learning model comprises:
determining the second machine learning model as the target machine learning model when determining that the first analysis result is the same as the second analysis result; or
determining the second machine learning model as the target machine learning model when determining that the first analysis result is different from the second analysis result and that the difference between the first analysis result and the second analysis result is less than or equal to a threshold difference, the threshold difference being determined by the second computing device in training the second machine learning model.

4. The method according to claim 3, further comprising:
updating the first machine learning model with the second machine learning model that is determined as the target machine learning model.

5. The method according to claim 1, wherein a computing capability of the first computing device is lower than a computing capability of the second computing device, and a speed of communication between the first computing device and the data collector is higher than a speed of communication between the second computing device and the data collector.

6. The method according to claim 1, wherein the first computing device is an edge computing node, the second computing device is included in a cloud computing architecture, and the data collector includes a sensor in the Internet of Things (IoT).

7. An electronic device, comprising:
at least one processing unit; and
at least one memory that is coupled to the at least one processing unit and has machine-executable instructions stored therein, wherein the instructions, when executed by the at least one processing unit, cause the device to perform actions comprising:
determining, with a first machine learning model deployed at a first computing device, a first analysis result for to-be-analyzed data received from a data collector;
determining, with a second machine learning model received from a second computing device, a second analysis result for the to-be-analyzed data, the second computing device being different from the first computing device; and
determining, based on a comparison of the first analysis result and the second analysis result, a target machine learning model from the first machine learning model and the second machine learning model for use in analyzing additional to-be-analyzed data received from the data collector.

8. The device according to claim 7, wherein determining the second analysis result with the second machine learning model comprises:
determining a first computing resource that is used to determine the first analysis result with the first machine learning model and a second computing resource that is used to determine the second analysis result with the second machine learning model; and
determining the second analysis result with the second machine learning model when determining that the sum of the first computing resource and the second computing resource is less than or equal to a threshold computing resource.

9. The device according to claim 7, wherein determining the target machine learning model comprises:
determining the second machine learning model as the target machine learning model when determining that the first analysis result is the same as the second analysis result; or
determining the second machine learning model as the target machine learning model when determining that the first analysis result is different from the second analysis result and that the difference between the first analysis result and the second analysis result is less than or equal to a threshold difference, the threshold difference being determined by the second computing device in training the second machine learning model.

10. The device according to claim 9, wherein the actions further comprise:
updating the first machine learning model with the second machine learning model that is determined as the target machine learning model.

11. The device according to claim 7, wherein a computing capability of the first computing device is lower than a computing capability of the second computing device, and a speed of communication between the first computing device and the data collector is higher than a speed of communication between the second computing device and the data collector.

12. The device according to claim 7, wherein the first computing device is an edge computing node, the second computing device is included in a cloud computing architecture, and the data collector includes a sensor in the Internet of Things (IoT).

13. A computer program product tangibly stored in a non-transitory computer-readable medium and comprising machine-executable instructions, wherein the machine-executable instructions, when executed, cause a machine to perform steps of a method for updating a machine learning model, the method comprising:
determining, with a first machine learning model deployed at a first computing device, a first analysis result for to-be-analyzed data received from a data collector;
determining, with a second machine learning model received from a second computing device, a second analysis result for the to-be-analyzed data, the second computing device being different from the first computing device; and
determining, based on a comparison of the first analysis result and the second analysis result, a target machine learning model from the first machine learning model and the second machine learning model for use in analyzing additional to-be-analyzed data received from the data collector.

14. The computer program product according to claim 13, wherein determining the second analysis result with the second machine learning model comprises:
determining a first computing resource that is used to determine the first analysis result with the first machine learning model and a second computing resource that is used to determine the second analysis result with the second machine learning model; and
determining the second analysis result with the second machine learning model when determining that the sum of the first computing resource and the second computing resource is less than or equal to a threshold computing resource.

15. The computer program product according to claim 13, wherein determining the target machine learning model comprises:
determining the second machine learning model as the target machine learning model when determining that the first analysis result is the same as the second analysis result; or
determining the second machine learning model as the target machine learning model when determining that the first analysis result is different from the second analysis result and that the difference between the first analysis result and the second analysis result is less than or equal to a threshold difference, the threshold difference being determined by the second computing device in training the second machine learning model.

16. The computer program product according to claim 15, wherein the method further comprises:
updating the first machine learning model with the second machine learning model that is determined as the target machine learning model.

17. The computer program product according to claim 13, wherein a computing capability of the first computing device is lower than a computing capability of the second computing device, and a speed of communication between the first computing device and the data collector is higher than a speed of communication between the second computing device and the data collector.

18. The computer program product according to claim 13, wherein the first computing device is an edge computing node, the second computing device is included in a cloud computing architecture, and the data collector includes a sensor in the Internet of Things (IoT).
